(19) United States
(12) Patent Application Publication
(10) Pub. No.: US 2017/0040827 A1
(43) Pub. Date: Feb. 9, 2017

(54) CLOSURE MEMBER WIRELESS POWER SYSTEM FOR A CLOSABLE OPENING

(71) Applicant: TYCO ELECTRONICS CORPORATION, Berwyn, PA (US)

(72) Inventor: Ronald Martin Weber, Annville, PA (US)

(21) Appl. No.: 14/820,063

(22) Filed: Aug. 6, 2015

(51) Int. Cl. H02J 7/02; H02J 50/10; H02J 50/80; E05B 47/00

(52) U.S. Cl. CPC H02J 7/025; E05B 47/00; H02J 50/10; H02J 50/80; E05B 2047/0058; E05B 2047/0068

(57) ABSTRACT

A wireless door lock power system includes a power transmitter configured to be coupled to a building power supply having a transmit face at or near a door jamb and a power receiver configured to be coupled to a door closably received in the doorjamb. The power receiver has a receive face at or near an edge of the door. The power receiver receives a wireless power transmission from the power transmitter. A chargeable battery is received in the door. The battery is electrically coupled to the power receiver. The battery receives power from the power receiver to recharge the battery. An electronic door lock is operably coupled to the battery. The electronic door lock has a lock electronically actuated to lock the door to the doorjamb.

### BACKGROUND OF THE INVENTION

The subject matter herein relates generally to wireless power systems for a closure member in a closable opening.

Closable openings have closure members associated therewith that open and close the closable opening. For example, a door may be received in a doorway, which opens and closes the opening to the building or structure. Other examples may include a window received in a window opening, which opens and closes the opening to the building or structure.

Some applications have a need for powering electrical components associated with the closure member. For example, some applications have an electronic lock for locking and unlocking the closure member. An electronic keypad is provided that unlocks the electronic lock. The electronic lock may or may not include a radio system for communicating with a home automation system or other controlling device. The electronic lock requires power to actuate the electronic lock. Typically, a battery is provided in the electronic lock assembly. The battery needs to be replaced often, which may be tedious. The housing of the electronic lock must be large enough to hold the battery. To avoid the use of a battery, and thus eliminate the need for replacing batteries, some applications have been proposed that hard wire the electronic lock to building power. For example, a power wire spans from the door frame to the door at the hinged side of the door. The wire is routed through the door to the latching and locking side of the door. It is difficult and expensive to route wires to provide power to the lock assembly.

A need remains for a wireless system for a closure member in a closable opening that may transfer power and/or data to a closure member.

### BRIEF DESCRIPTION OF THE INVENTION

In one embodiment, a wireless door lock power system is provided including a power transmitter configured to be coupled to a building power supply having a transmit face at or near a door jamb and a power receiver configured to be coupled to a door closably received in the door jamb. The power receiver has a receive face at or near an edge of the door. The power receiver receives a wireless power transmission from the power transmitter. A chargeable battery is received in the door. The battery is electrically coupled to the power receiver. The battery receives power from the power receiver to recharge and maintain the charge of the battery. An electronic door lock is operably coupled to the battery. The electronic door lock has a lock electronically actuated to lock the door to the doorjamb.

In a further embodiment, a closure member wireless power system for a closable opening is provided including a power transmitter configured to be coupled to a power supply. The power transmitter has a transmit face at or near an edge of a frame of the closable opening. The wireless power system also includes a power receiver configured to be coupled to a closure member closably received in the frame of the closable opening. The power receiver has a receive face at or near an edge of the closure member. The power receiver receives a wireless power transmission from the power transmitter. The wireless power system includes a powered electrical component mounted to or housed in the closure member. The powered electrical component is electrically connected to and powered by the power receiver and/or the battery it is connectect to.

### BRIEF DESCRIPTION OF THE DRAWINGS

FIG. 1 is a schematic illustration of a wireless power system for a closure member within a closeable opening of a structure or building in accordance with an exemplary embodiment.

FIG. 2 illustrates a wireless power system for a door within a doorway of a structure or building in accordance with an exemplary embodiment.

FIG. 3 is a schematic circuit diagram of the wireless power system shown in FIG. 2.

FIG. 4 illustrates the wireless power system using a wireless power system formed in accordance with an exemplary embodiment.

FIG. 5 illustrates a wireless power system for a window within a window opening in accordance with an exemplary embodiment.

### DETAILED DESCRIPTION OF THE INVENTION

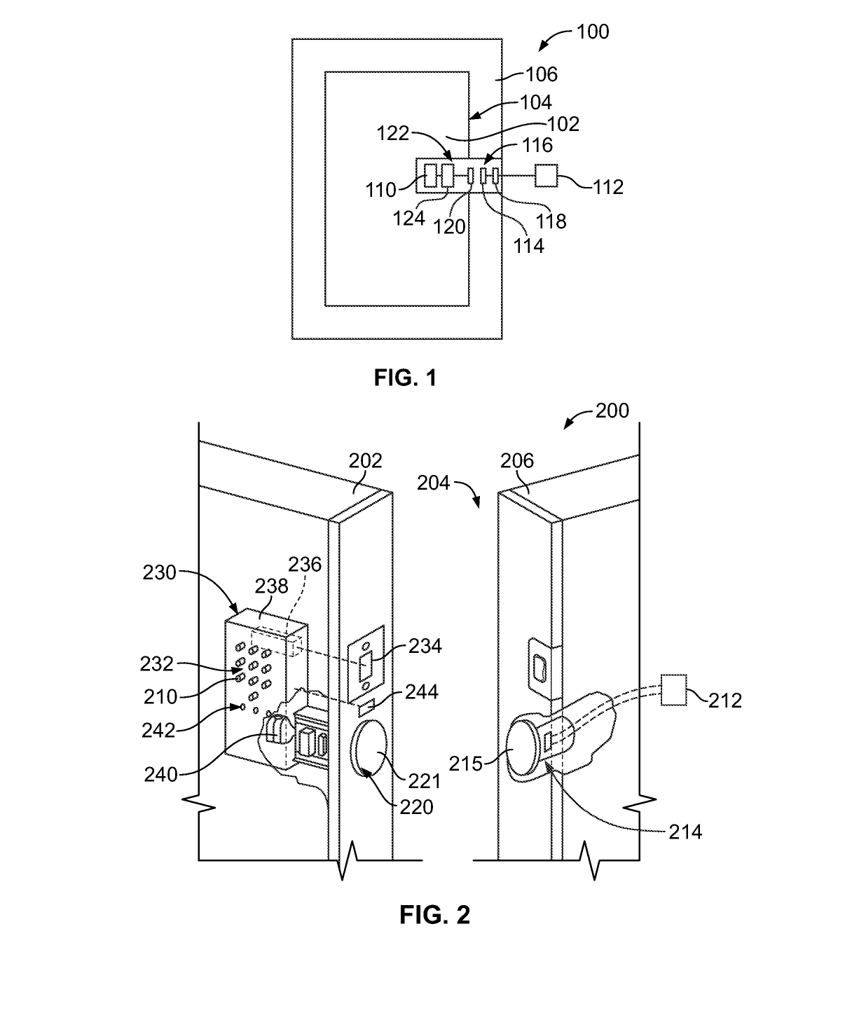

FIG. 1 is a schematic illustration of a wireless power system 100 for a closure member 102 within a closeable opening 104 of a structure or building. The wireless power system 100 is used to provide power to one or more powered electrical components 110 mounted to or housed in the closure member 102. The closure member 102 is received in a frame 106 of the closeable opening 104. The closure member 102 may close the opening 104.

The closure member 102 is moveably coupled to the frame 106 to open and close the opening 104. For example, the closure member 102 may be a door or a window and the closeable opening 104 may be a doorway or window opening in the structure or building. The frame 106 may be a door jamb or window jamb around the door or window. The closure member 102 may be rotatably coupled to the frame 106. The closure member 102 may be slidably coupled to the frame 106 to open and close the opening 104.

The wireless power system 100 wirelessly provides power across the threshold or interface between the closure member 102 and the frame 106 of the closeable opening 104 for powering the powered electrical component 110, such as when the closure member 102 is closed. The wireless power system 100 may be an inductive system that creates a magnetic field to wirelessly transmit power. Other types of wireless power systems may be provided in alternative embodiments, such as a capacitive transfer system, an optical power system using a high power, focused light source that may be used to wirelessly power a photocell or other component, or another type of power transfer system.

The wireless power system 100 includes a power supply 112, which may be tied into the building power supply. For example, the power supply 112 may be connected to line AC power or low voltage DC power. The wireless power system 100 includes a power transmitter 114 coupled to the power supply 112 as part of a power transmitting circuit 116. The power transmitter 114 is configured to transmit or wirelessly supply power within the wireless power system 100. The power transmitter 114 is coupled to the frame 106 and is held in position relative to the closeable opening 104 for interfacing with the closure member 102 when the closure member 102 is in the closed position.

Optionally, a controller 118 may be associated with the power transmitting circuit 116 for controlling the power transmitting circuit 116. For example, the controller 118 may turn the power transmitter 114 on and off The controller 118 may disconnect power to the power transmitter 114 from the power supply 112, such as when the closure member 102 is open and/or when the wireless powered electrical component 110 does not need power.

The wireless power system 100 includes a power receiver 120 configured to receive a wireless power transmission from the power transmitter 114. The power receiver 120 is coupled to the closure member 102 and is moveable with the closure member 102 within the closeable opening 104. The power receiver 120 is electrically connected to the powered electrical component 110. The power receiver 120 and the powered electrical component 110 are part of a power receiving circuit 122. The power receiving circuit 122 may include a controller 124 for controlling the power receiving circuit 122. The controller 124 may control a supply of power from the power receiver 120 to the power receiving circuit 122.

The powered electrical component 110 may be any type of powered electrical component 110 usable with the closure member 102. Optionally, multiple powered electrical components 110 may be provided. The powered electrical component 110 may be a battery configured to receive power from the power supply 112 through the wireless power link between the power transmitter 114 and the power receiver 120. The battery may store power for other powered electrical components 110. The battery may be rechargeable using the power supply to the power receiver 120.

In an exemplary embodiment, the powered electrical component 110 is an electronic lock for locking and unlocking the closure member 102. For example, the closure member 102 may be a door and the powered electrical component 110 may be an electronic door lock operably coupled to the power transmitter 114 and/or the battery. The electronic lock may include a lock element that is electronically actuated to lock the closure member 102 to the frame 106. Other types of powered electrical components 110 may be provided in alternative embodiments. For example, the powered electrical component 110 may be a window lock used to lock and unlock the window (closure member 102) within the window frame.

In other various embodiments, the powered electrical component 110 may be an LED or LED array, which may be used to identify a status of the closure member 102, such as if the closure member is locked, if the closure member is unlocked, if the closure member is open, if the closure member is closed and/or other information regarding the closure member 102 or other components of the wireless power system 100, such as a status of the battery.

The powered electrical component 110 may be a display screen or user interface on the closure member 102. For example, the powered electrical component 110 may be an electronic key pad powered by the wireless power system 100. The powered electrical component 110 may be a camera in other various embodiments which may be powered by the wireless power system 100. The powered electrical component 110 may be a wireless data transmitter or a wireless data receiver in various embodiments. Electrical component 110 may also be any combination of wireless data devices and other powered electrical components.

The powered electrical component may be a sensor associated with the closure member 102, such as a sensor configured to determine if the door is open, if the door is closed, if the door is locked, if the door is unlocked or other information relating to the closure member 102. The sensor may be a light sensor configured to determine how much light the closure member 102 is receiving, such as when the closure member is a window. The sensor may be a counter configured to count a number of people passing through the closable opening 104. Other types of powered electrical components 110 may be provided in alternative embodiments, which are powered by the wireless power system 100. For example, the powered electrical component 110 may be a wireless radio for communication with a home automation system or other remote control device.

FIG. 2 illustrates a wireless power system 200 for a closure member 202 within a closeable opening 204 of a structure or building. In the illustrated embodiment, the closure member 202 is a door and may be referred to hereinafter as door 202. The closable opening 204 is a doorway and may be referred to hereinafter as doorway 204. The wireless power system 200 is used to provide power to one or more powered electrical components 210 mounted to or housed in the door 202. The door 202 is received in a frame 206 of the doorway 204. The door 202 may close the doorway 204.

The door 202 is moveably coupled to the frame 206 to open and close the doorway 204. The frame 206 may be a door jamb around the door 202. The door 202 may be rotatably coupled to the frame 206 to open and close the doorway 204. The door 202 may be slidably coupled to the frame 206 to open and close the doorway 204.

The wireless power system 200 wirelessly provides power across the threshold or interface between the door 202 and the frame 206 of the doorway 204 for powering the powered electrical component 210, such as when the door 202 is closed. The wireless power system 200 may be an inductive system that creates a magnetic field to wirelessly transmit power. Other types of wireless power systems may be provided in alternative embodiments, such as a capacitive transfer system, an optical power system using a high power, focused light source that may be used to wirelessly power a photocell or other component, or another type of wireless power system.

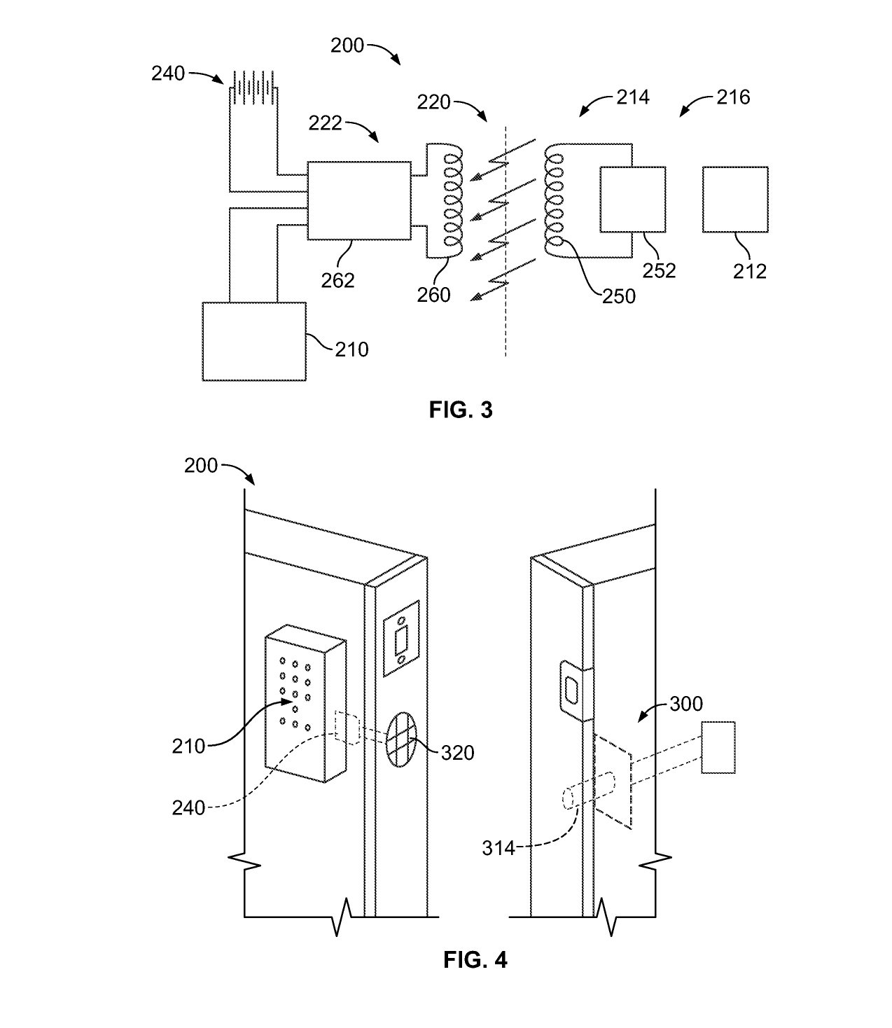

The wireless power system 200 includes a power supply 212, which may be tied into the building power supply. For example, the power supply 212 may be connected to line AC power or low voltage DC power. The wireless power system 200 includes a power transmitter 214 coupled to the power supply 212 as part of a power transmitting circuit 216 (FIG. 3). The power transmitter 214 is configured to transmit or wirelessly supply power within the wireless power system 200. The power transmitter 214 is coupled to the frame 206 and is held in position relative to the doorway 204 for interfacing with the door 202 when the door 202 is in the closed position. Optionally, the power transmitter 214 may be flush with the frame 206. Alternatively, the power transmitter 214 may be recessed or may protrude from the frame 206. Optionally, the location of the power transmitter 214, such as the spacing from the door 202, may control an amount of wireless power transfer from the power transmitter 214. The power transmitter 214 includes a transmit face 215. The transmit face 215 may be flat. The transmit face 215 may have any shape and in the illustrated embodiment is circular. Optionally, the size of the transmit face 215 may control an amount of wireless power transfer from the power transmitter 214.

The wireless power system 200 includes a power receiver 220 configured to receive a wireless power transmission from the power transmitter 214. The power receiver 220 is coupled to the door 202 and is moveable with the door 202 within the doorway 204. The power receiver 220 is electrically connected to the powered electrical component 210. The power receiver 220 and the powered electrical component 210 are part of a power receiving circuit 222 (FIG. 3).

The power receiver 220 is coupled to the door 202 and is held in position relative to the doorway 204 for interfacing with the power transmitter 214 when the door 202 is in the closed position. Optionally, the power receiver 220 may be flush with the frame 206. Alternatively, the power receiver 220 may be recessed or may protrude from the frame 206. Optionally, the location of the power receiver 220, such as the spacing from the power transmitter 214, may control an amount of wireless power transfer from the power transmitter 214. The power receiver 220 includes a receive face 221. The receive face 221 may be flat. The receive face 221 may have any shape and in the illustrated embodiment is circular. Optionally, the size of the receive face 221 may control an amount of wireless power transfer received from the power transmitter 214.

The powered electrical component 210 may be any type of powered electrical component 210 usable with the door 202. Optionally, multiple powered electrical components 210 may be provided. In the illustrated embodiment, the powered electrical components 210 include an electronic door lock 230 for locking and unlocking the door 202. The electronic door lock 230 includes a user interface 232, such as a keypad, for operating the electronic door lock 230. The electronic door lock 230 includes a lock element 234 that is electronically actuated by an electronic actuator 236 to lock the door 202 to the frame 206. The electronic actuator 236 may be housed within a housing 238 of the electronic door lock 230, which is mounted to the door 202 and may be at least partially received in the door 202.

The powered electrical components 210 include a battery 240 configured to receive power from the power supply 212 through the wireless power link between the power transmitter 214 and the power receiver 220. The battery 240 may store power for other powered electrical components 210, such as for the electronic door lock 230. For example, the battery 240 may be electrically connected to the electronic actuator 236. The battery 240 may be rechargeable using the power supply to the power receiver 220. The battery 240 may be housed within the housing 238. The battery 240 may be housed within the door 202. Because the battery 240 is rechargeable by the power received through the power receiver 220, the battery 240 may be smaller than a battery that is not rechargeable, such as those used in conventional electronic door lock systems. As such, the housing 238 holding the battery 240 may be smaller or the battery 240 may be housed in another area of the door 202, such as an area that is less accessible because the battery 240 does not need to be accessed by the user to change the battery 240 because the battery 240 is rechargeable by the power receiver 220. Additionally, the battery 240 does not need to have a directly power line routed thereto (e.g., through the hinged side of the door 202 because the battery 240 receives power wirelessly across the wireless power link.

In other various embodiments, the powered electrical component 210 may be an LED or LED array 242, which may be used to identify a status of the door 202, such as if the door 202 is locked, if the door 202 is unlocked, if the door 202 is open, if the door 202 is closed and/or other information regarding the door 202 or other components of the wireless power system 200, such as a status of the battery. The powered electrical component 210 may be a sensor 244 associated with the door 202, such as a sensor configured to determine if the door 202 is open, if the door 202 is closed, if the door 202 is locked, if the door 202 is unlocked or other information relating to the door 202.

Other types of powered electrical components 210 may be provided in alternative embodiments, which are powered by the wireless power system 200. For example, the powered electrical component 210 may be a display screen on the door 202. The powered electrical component 210 may be a camera in other various embodiments which may be powered by the wireless power system 200. The powered electrical component 210 may be a wireless data transmitter or a wireless data receiver in various embodiments. For example, the powered electrical component 110 may be a wireless radio for communication with a home automation system or other remote control device.

FIG. 3 is a schematic circuit diagram of the wireless power system 200. The power supply 212 (e.g., line AC power or low voltage DC power) is coupled to the power transmitter 214. In the illustrated embodiment, the power transmitter 214 includes a transmit coil 250 configured coupled to the power supply 212 as part of the power transmitting circuit 216. The transmit coil 250 generates a magnetic field when powered, which emanates from the transmit coil 250.

In an exemplary embodiment, the power transmitting circuit 216 includes a controller 252 may be associated with the power transmitting circuit 216 for controlling the power transmitting circuit 216. The controller 252 may turn the power transmitter 214 on and off For example, the controller 252 may connect and disconnect power to and from the power supply 212, such as when the door 202 is open and/or when the wireless powered electrical component 210 does not need power. The controller 252 may include conditioning circuitry for conditioning the power supplied to the power transmitter 214.

The power receiver 220 receives the wireless power transmission from the power transmitter 214. In an exemplary embodiment, the power receiver 220 includes a receive coil 260. The receive coil 260 is inductively coupled to the transmit coil 250 when in the proximity of the receive coil 260, such as when the door 202 (FIG. 2) is closed. The power receiver 220 is electrically connected to the powered electrical component 210, such as via a wired connection and/or an electrical connection through a circuit board. The receive coil 260 is part of the power receiving circuit 222. One or more of the powered electrical components 210 may be part of the power receiving circuit 222.

The power receiving circuit 222 includes a controller 262 for controlling the power receiving circuit 222. The controller 262 may control the supply of power from the power receiver 220 to the powered electrical components 210. For example, the controller 262 may control the supply of power to the battery 240. The controller 262 may control the supply of power from the battery 240 to the other powered electrical components 210, such as the electronic door lock 230. The controller 262 may turn the power receiver 220 on and off. For example, the controller 262 may connect and disconnect power between the power receiver 220 and the battery 240, such as when the door 202 is open and/or when the battery 240 is fully charged and/or the various powered electrical components do not need power. The controller 262 may include conditioning circuitry for conditioning the power supplied from the power receiver 220 to the battery 240 and/or from the battery 240 to the other powered electrical components 210.

FIG. 4 illustrates the wireless power system 200 using an optical power system 300 for wireless power transfer. The optical power system 300 includes a high power, focused light source 314 as a power transmitter and a photocell 320 or other component as a power receiver. The light source 314 is used to wirelessly power the powered electrical components 210. For example, the photocell 320 converts the light from the light source 314 into power, which is used to power the powered electrical components 210. For example, the power generated by the photocell 320 may be used to charge the battery 240.

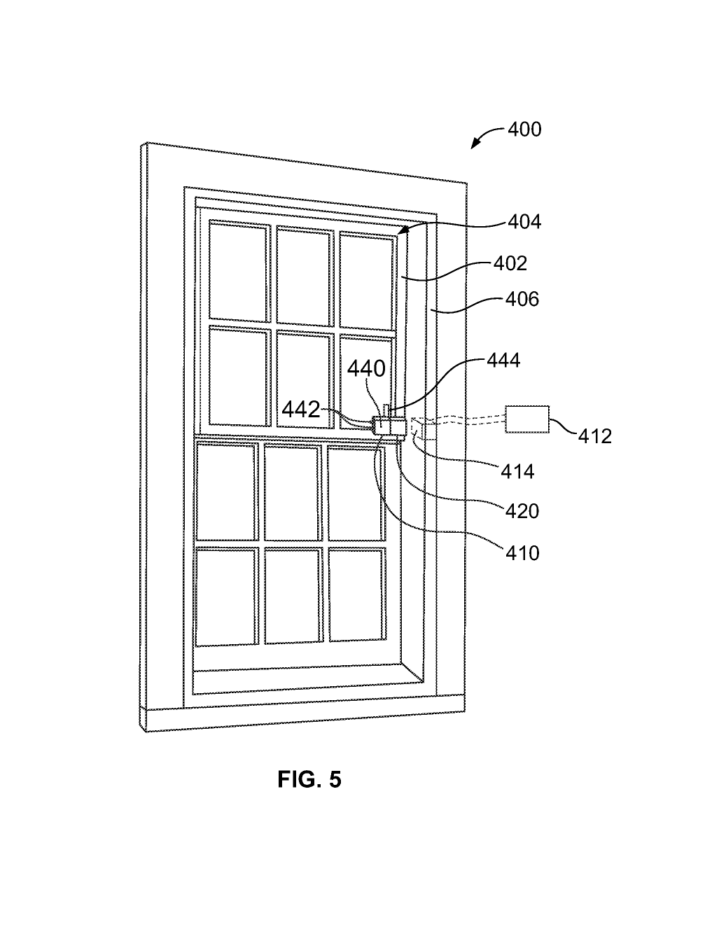

FIG. 5 illustrates a wireless power system 400 for a closure member 402 within a closeable opening 404 of a structure or building. In the illustrated embodiment, the closure member 402 is a window and may be referred to hereinafter as window 402. The wireless power system 400 is used to provide power to one or more powered electrical components 410 mounted to or housed in the window 402. The window 402 is received in a frame 406 of the opening 404. The window 402 may close the opening 404.

The window 402 is moveably coupled to the frame 406 to open and close the opening 404. The window 402 may be rotatably coupled to the frame 406 to open and close the opening 404. The window 402 may be slidably coupled to the frame 406 to open and close the opening 404.

The wireless power system 400 wirelessly provides power across the threshold or interface between the window 402 and the frame 406 of the opening 404 for powering the powered electrical component 410, such as when the window 402 is closed. The wireless power system 400 may be an inductive system that creates a magnetic field to wirelessly transmit power. Other types of wireless power systems may be provided in alternative embodiments, such as an optical power system using a high power, focused light source that may be used to wirelessly power a photocell or other component.

The wireless power system 400 includes a power supply 412, which may be tied into the building power supply. The wireless power system 400 includes a power transmitter 414 coupled to the power supply 412 as part of a power transmitting circuit. The power transmitter 414 is configured to transmit or wirelessly supply power within the wireless power system 400. The power transmitter 414 is coupled to the frame 406 and is held in position relative to the opening 404 for interfacing with the window 402 when the window 402 is in the closed position.

The wireless power system 400 includes a power receiver 420 configured to receive a wireless power transmission from the power transmitter 414. The power receiver 420 is coupled to the window 402 and is moveable with the window 402 within the opening 404. The power receiver 420 is electrically connected to the powered electrical component 410. The power receiver 420 and the powered electrical component 410 are part of a power receiving circuit.

The powered electrical component 410 may be any type of powered electrical component 410 usable with the window 402. Optionally, multiple powered electrical components 410 may be provided. The powered electrical components 410 include a battery 440 configured to receive power from the power supply 412 through the wireless power link between the power transmitter 414 and the power receiver 420. The battery 440 may store power for other powered electrical components 410. The battery 440 may be rechargeable using the power supply to the power receiver 420.

In other various embodiments, the powered electrical component 410 may be an LED or LED array 442, which may be used to identify a status of the window 402, such as if the window 402 is locked, if the window 402 is unlocked, if the window 402 is open, if the window 402 is closed and/or other information regarding the window 402 or other components of the wireless power system 400, such as a status of the battery. The powered electrical component 410 may be a sensor 444 associated with the window 402, such as a sensor configured to determine if the window 402 is open, if the window 402 is closed, if the window 402 is locked, if the window 402 is unlocked or other information relating to the window 402. The sensor 444 may be a light sensor configured to detect sunlight. The sensor 444 may be an environmental sensor configured to measure at least one of temperature and humidity exterior of the window 402.

Other types of powered electrical components 410 may be provided in alternative embodiments, which are powered by the wireless power system 400. For example, the powered electrical components 410 include an electronic window lock for locking and unlocking the window 402. The powered electrical component 410 may be a display screen on the window 402. The powered electrical component 410 may be a camera in other various embodiments which may be powered by the wireless power system 400. The powered electrical component 410 may be a wireless data transmitter or a wireless data receiver in various embodiments or in combination with other electrical or electronic components. For example, the powered electrical component 110 may be a wireless radio for communication with a home automation system or other remote control device.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

What is claimed is:

1. A wireless door lock power system comprising:
a power transmitter configured to be coupled to a building power supply, the power transmitter having a transmit face at or near a door jamb;
a power receiver configured to be coupled to a door closably received in the doorjamb, the power receiver having a receive face at or near an edge of the door, the power receiver receiving a wireless power transmission from the power transmitter;
a chargeable battery received in the door, the battery being electrically coupled to the power receiver, the battery receiving power from the power receiver to recharge the battery; and
an electronic door lock operably coupled to the battery, the electronic door lock having a lock electronically actuated to lock the door to the doorjamb.

2. The wireless door lock power system of claim 1, wherein the power transmitter includes an inductive transmit coil and the power receiver includes an inductive receive coil.

3. The wireless door lock power system of claim 1, wherein the power transmitter includes an optical transmitter configured to transmit light and the power receiver includes an optical receiver configured to receive the transmitted light and convert the received light into power.

4. The wireless door lock power system of claim 1, wherein the power transmitter and the power receiver define a wireless power link across the door threshold configured to transfer power wirelessly when the door is closed and adjacent the doorjamb.

5. The wireless door lock power system of claim 1, wherein the power transmitter and the power supply are part of a power transmitting circuit, the power transmitting circuit comprising a controller to control the power transmitting circuit.

6. The wireless door lock power system of claim 5, wherein the controller disconnects power to the power transmitter when the door is open.

7. The wireless door lock power system of claim 1, wherein the power receiver and the battery are part of a power receiving circuit, the power receiving circuit comprising a controller to control the power receiving circuit.

8. The wireless door lock power system of claim 7, wherein the controller controls a supply of power to the battery.

9. The wireless door lock power system of claim 7, wherein the controller controls a supply of power to the electronic door lock.

10. The wireless door lock power system of claim 1, further comprising a powered electrical component mounted to or housed in the door, the powered electrical component operably coupled to the battery.

11. The wireless door lock power system of claim 10, wherein the powered electrical component is one of an LED, a display screen, or a camera.

12. The wireless door lock power system of claim 10, wherein the powered electrical component is a sensor configured to determine at least one of if the door is open, if the door is closed, if the door is locked, and if the door is unlocked.

13. The wireless door lock power system of claim 10, wherein the powered electrical component is at least one of a wireless data transmitter and a wireless data receiver for data communication with external devices.

14. A closure member wireless power system for a closable opening, the wireless power system comprising:
a power transmitter configured to be coupled to a power supply, the power transmitter having a transmit face at or near an edge of a frame of the closable opening;
a power receiver configured to be coupled to a closure member closably received in the frame of the closable opening, the power receiver having a receive face at or near an edge of the closure member, the power receiver receiving a wireless power transmission from the power transmitter; and
a powered electrical component mounted to or housed in the closure member, the powered electrical component being electrically connected to and powered by the power receiver.

15. The wireless power system of claim 14, wherein the powered electrical component comprises a chargeable battery received in the closure member, the battery being electrically coupled to the power receiver, the battery receiving power from the power receiver to recharge the battery.

16. The wireless power system of claim 14, wherein the powered electrical component comprises an electronic door lock having a lock electronically actuated to lock the closure member to the frame of the closable opening.

17. The wireless power system of claim 14, wherein the closure member is a window, the powered electrical component comprising a sensor associated with the window.

18. The wireless power system of claim 14, wherein the powered electrical component includes a sensor configured to determine at least one of if the closure member is open, if the closure member is closed, if the closure member is locked, and if the closure member is unlocked.

19. The wireless power system of claim 16, wherein the powered electrical component includes an environmental sensor configured to measure at least one of temperature and humidity exterior of the closure member.

20. The wireless power system of claim 14, wherein the powered electrical component includes at least one of an LED mounted to the closure member, a display screen mounted to the closure member, and a camera mounted to the closure member.

21. The wireless power system of claim 14, wherein the power transmitter and the power supply are part of a power transmitting circuit, the power transmitting circuit comprising a controller to control the power transmitting circuit, the controller disconnecting power to the power transmitter when the door is open, and wherein the power receiver and the battery are part of a power receiving circuit, the power receiving circuit comprising a controller to control the power receiving circuit, the controller controlling a supply of power to the powered electrical component.
